(19) United States
(12) Patent Application Publication
(10) Pub. No.: US 2026/0019913 A1
(43) Pub. Date: Jan. 15, 2026

(54) MOBILITY MANAGEMENT VIA IAB NODES IN INACTIVE MODE

(71) Applicant: Sony Group Corporation, Tokyo (JP)

(72) Inventors: Lars NORD, Lund (SE); Torgny PALENIUS, Barsebäck (SE); Anders BERGGREN, Lund (SE)

(21) Appl. No.: 19/114,400

(22) PCT Filed: Oct. 9, 2023
(86) PCT No.: PCT/EP2023/077844

§ 371 Date: Mar. 21, 2025

(30) Foreign Application Priority Data
Oct. 10, 2022 (SE) 2251188-5

(51) Int. Cl. H04W 36/36

(52) U.S. Cl. CPC H04W 36/362

(57) ABSTRACT

The present disclosure relates to a method for use in a radio access network (RAN) node of a RAN of a cellular network. The RAN node connects integrated access and backhaul (IAB) relay nodes to the cellular network. The RAN node is associated with a RAN notification area (RNA) for mobility management of the wireless terminals operating in an inactive mode where a data connection between the respective wireless terminal and the RAN node is disconnected or suspended. The method comprises obtaining IAB RNA association information enabling the RAN node to prospectively associate IAB relay nodes that will newly connect to the RAN node with the same RNA as the RAN node, upon releasing a wireless terminal connected to the RAN node to the inactive mode, providing RNA information to the wireless terminal based on the previously obtained IAB RNA association information and upon an IAB relay node newly connecting to the RAN node, assigning a cell identity to the LAB relay node based on the previously obtained IAB RNA association information.

### TECHNICAL FIELD

The invention generally relates to mobility management of user equipments (UEs) and more precisely to mobility management of UEs connected to the core network via integrated access and backhaul (IAB) nodes.

### BACKGROUND

In 5G NR, a UE may be in an inactive mode, i.e. a mode from which the UE can return to a connected mode with less signaling. This quick return is enabled by the last serving radio access network (RAN) node storing the context of the UE. Here, the last serving RAN node refers to RAN node to which the UE was connected during a preceding connected mode before entering the inactive mode. Given that UEs are typically mobile, the RAN may define an area of the RAN, within which the UE can move without having to leave the inactive mode even if the UE moves from the coverage area of one RAN node to another. These areas may be referred to as RAN notification areas (RNAs). Within an RNA, the last serving RAN node continues to store the UE context and provides it to other RAN nodes of the RNA, should the UE switch to connected mode with one of the other RAN nodes.

In order to be able to remain in inactive mode when moving from the coverage area of one RAN node to the coverage area of another RAN node, the UE needs to be aware of the RNA. To this end, the UE may be provided with a definition of the RNA, which may take the form of a list of cell identities of RAN nodes belonging to a particular RNA. When the UE determines, based on the RNA definition, that it has left the RNA, the UE performs an RNA update by initiating RRC Resume procedure.

In 5G NR, a UE may not be directly coupled with RAN nodes but may instead be coupled to the RAN nodes via IAB nodes, which may, like the UE, be mobile. If the RNA is defined based on cell identities of RAN nodes, the UE coupled to the RAN node via an IAB node may erroneously assume to have left the RNA and may trigger an unwarranted RNA update. This leads to unwarranted signaling as well as a waste of energy at the UE due the transition from inactive mode to connected mode and the unwarranted signaling.

Therefore, it is an objective of the present invention to avoid unwarranted signaling of a mobile UE coupled to a cellular network via an IAB node in inactive mode.

### SUMMARY OF THE INVENTION

To achieve this objective, the present invention provides a method for use in a RAN node of a RAN of a cellular network. The RAN node connects IAB relay nodes to the cellular network, wherein the RAN node is associated with an RNA for mobility management of the wireless terminals operating in an inactive mode where a data connection between the respective wireless terminal and the RAN node is disconnected or suspended. The method comprises: obtaining IAB RNA association information enabling the RAN node to prospectively associate IAB relay nodes that will newly connect to the RAN node with the same RNA as the RAN node, upon releasing a wireless terminal connected to the RAN node to the inactive mode, providing RNA information to the wireless terminal based on the previously obtained IAB RNA association information, and upon an IAB relay node newly connecting to the RAN node, assigning a cell identity to the IAB relay node based on the previously obtained IAB RNA association information.

The present invention further provides a RAN node of a cellular network, the RAN node connecting IAB relay nodes to the cellular network, wherein the RAN node is associated with an RNA for mobility management of the wireless terminals operating in an inactive mode where a data connection between the respective wireless terminal and the RAN node is disconnected or suspended. The RAN node comprises a centralized unit (CU) configured to interface with a distributed unit (DU) of one or more IAB relay nodes and at least one DU configured to interface with at least an IAB UE of an IAB relay node. The CU is further configured to obtain IAB RNA association information enabling the RAN node to prospectively associate IAB relay nodes that will newly connect to the RAN node with the same RNA as the RAN node, upon releasing a wireless terminal connected to the RAN node to the inactive mode, provide RNA information to the wireless terminal based on the previously obtained IAB RNA association information and upon an IAB relay node newly connecting to the RAN node, assign a cell identity to the IAB relay node based on the previously obtained IAB RNA association information.

The present invention further provides a method for use in an IAB relay node connected to a cellular network through a RAN node of a RAN of the cellular network, the RAN node and the IAB relay node both being associated with an RNA for mobility management of the wireless terminals operating in an inactive mode where a data connection between the respective wireless terminal and the RAN node is disconnected or suspended. The method comprises broadcasting a cell identity assigned to the IAB relay node by the RAN node and broadcasting auxiliary information that is indicative of an association of the IAB relay node with the RNA.

Finally, the present invention further provides an IAB relay node connected to a cellular network through a RAN node of a RAN of the cellular network, the RAN node and the IAB relay node both being associated with an RNA for mobility management of the wireless terminals operating in an inactive mode where a data connection between the respective wireless terminal and the RAN node is disconnected or suspended. The IAB relay node comprises a DU configured to interface with a CU of a RAN node and one or more UEs and an IAB UE configured to interface with a DU of the RAN node. The DU of the IAB node is further configured to broadcast a cell identity assigned to the IAB relay node by the RAN node and broadcast auxiliary information that is indicative of an association of the IAB relay node with the RNA.

### BRIEF DESCRIPTION OF THE DRAWINGS

Embodiments of the present invention will be described with reference to the following appended drawings, in which like reference signs refer to like elements.

FIG. 1 schematically illustrates a mobile UE connected to an exemplary cellular network via IAB relay nodes according to embodiments of the present invention.

FIG. 2 provides block diagrams of various network nodes shown in FIG. 1 and an overview of their connections according to embodiments of the present invention.

FIG. 3 schematically illustrates a RAN node according to embodiments of the present invention.

FIG. 4 schematically illustrates a wireless terminal according to embodiments of the present invention.

FIG. 5 provides a flowchart of a method for use in a RAN node according to embodiments of the present invention.

FIG. 6 provides a signalling diagram of the method of FIG. 5 according to embodiments of the present invention.

FIG. 7 provides a flowchart of a method for use in an IAB relay node according to embodiments of the present invention.

FIG. 8 provides a signalling diagram of the method of FIG. 7 according to embodiments of the present invention.

FIG. 9 schematically illustrates a method for updating an RNA according to embodiments of the present invention.

It should be understood that the above-identified drawings are in no way meant to limit the disclosure of the present invention. Rather, these drawings are provided to assist in understanding the invention. The person skilled in the art will readily understand that aspects of the present invention shown in one drawing may be combined with aspects in another drawing or may be omitted without departing from the scope of the present invention.

### DETAILED DESCRIPTION

The present disclosure generally provides methods for use in RAN nodes and in IAB relay nodes enabling associating IAB relay nodes with the same RNA as the RAN node to which the IAB relay nodes are coupled. In addition to enabling this association, the present disclosure ensures that wireless terminals in an inactive mode are aware of the association of the IAB relay node with the RNA. Both the association and the awareness of the association may e.g. be achieved based on IAB RNA association information enabling the RAN node to prospectively associate IAB relay nodes that will newly connect to the RAN node with the same RNA as the RAN node or based on broadcasting auxiliary information that is indicative of an association of the IAB relay node with the RNA.

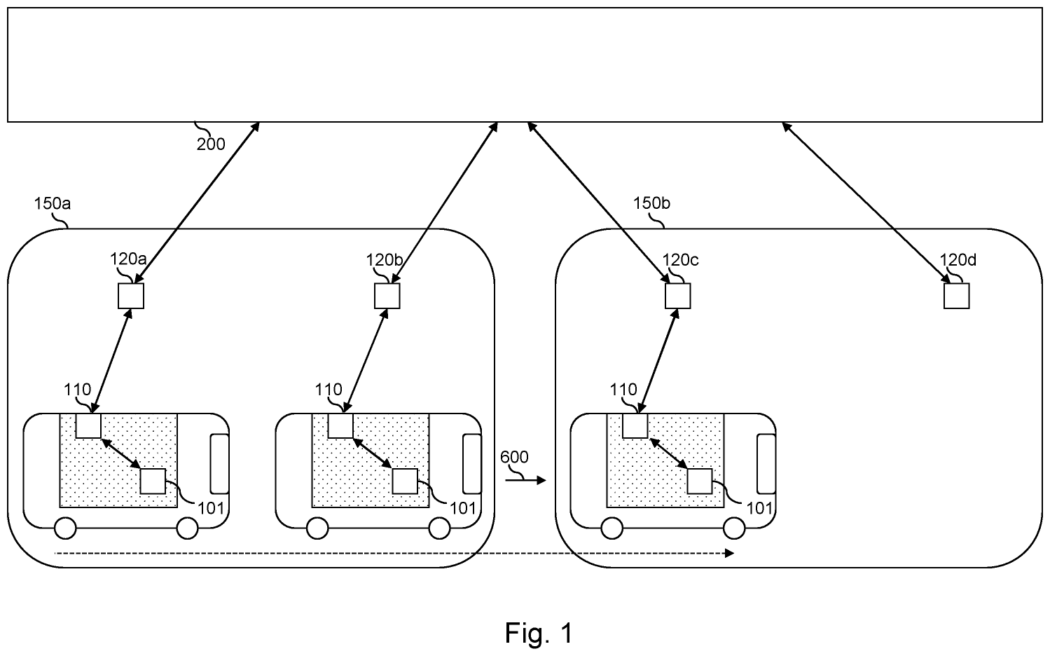

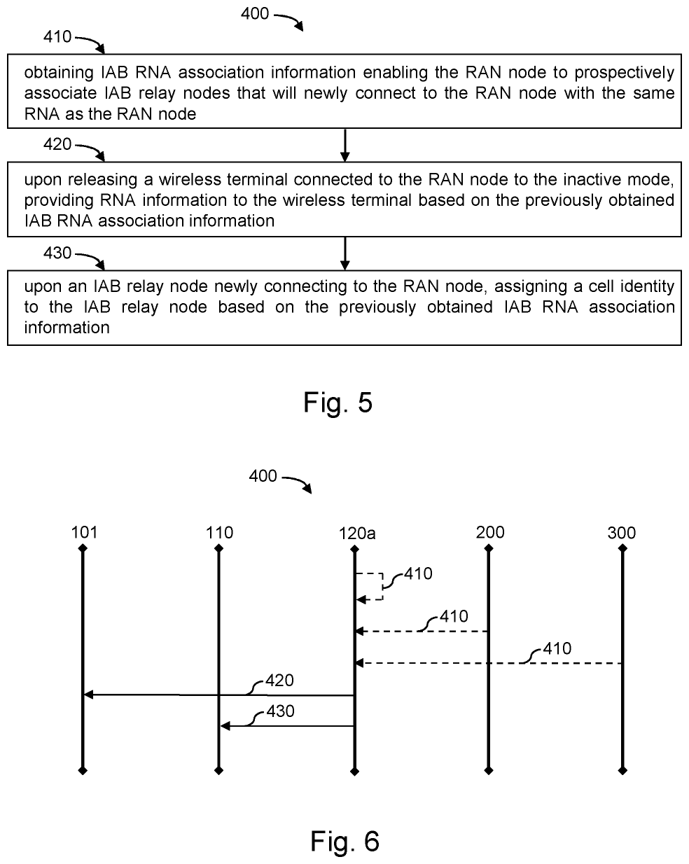

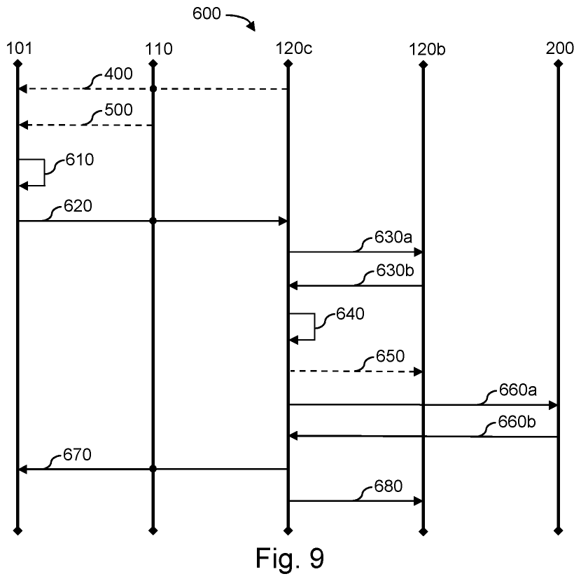

This general concept will be explained with reference to the appended drawings. FIGS. 1 to 4 provide a general overview of various aspects of the cellular network. Based on this general overview, FIGS. 5 to 8 illustrate the methods for use in RAN nodes and in IAB nodes enabling associating IAB nodes with the same RNA as the RAN node. Finally, FIG. 9 illustrates a method for updating an RNA, which may be performed by a wireless terminal.

FIG. 1 schematically illustrates a wireless terminal 101 connected to an exemplary cellular network comprising an IAB relay node 110, four RAN nodes 120a to 120d forming a RAN and a core network 200. The bi-directional communication between wireless terminal 101 and the various nodes of the cellular network are illustrated with arrows between the respective entities.

Core network 200 in the context of the present disclosure refers to the 5G core network. Accordingly, core network 200 is built using a service-based architecture (SBA). In other words, core network 200 comprises various functions which interface with one another and provide connectivity and related functionality between the RAN and other networks, such as the Internet.

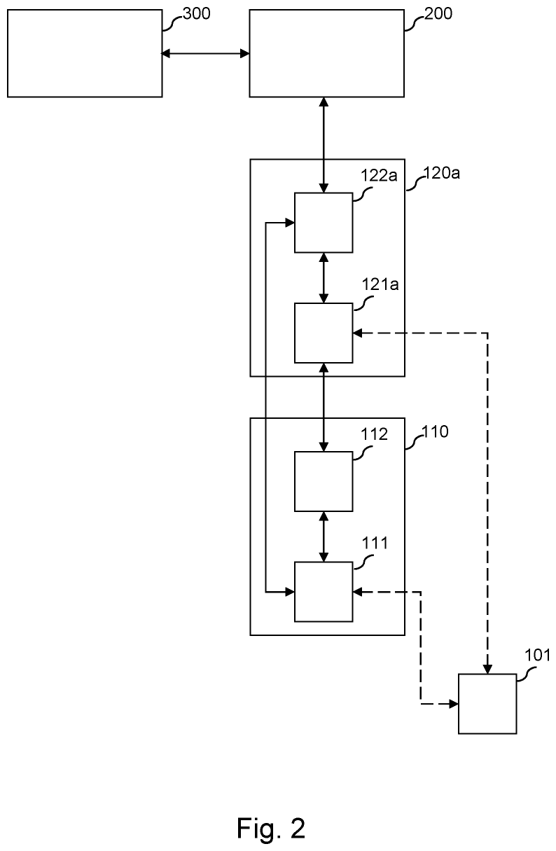

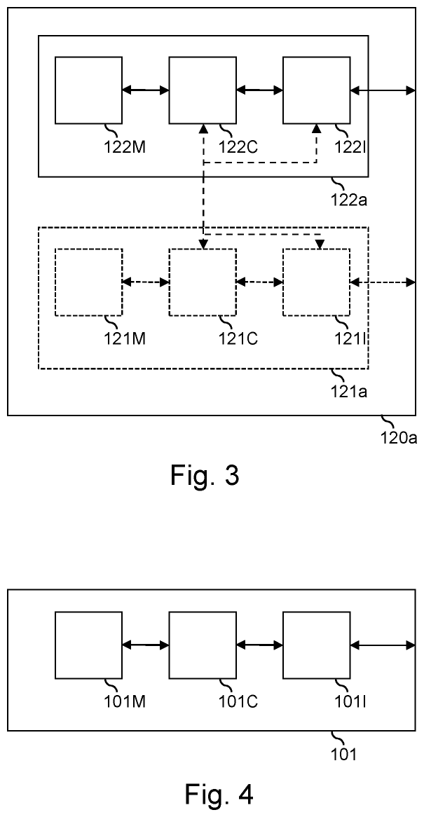

As stated above, RAN nodes 120a to 120d form a RAN and thereby provide an air interface for UEs, such as wireless terminal 101. The air interface, also referred to as a Uu interface, enables wireless terminal 101 to connect to core network 200 and thus to other networks coupled to core network 200. The structure of RAN nodes 120a to 120d will be discussed in more detail with regard to FIGS. 2 and 3.

Wireless terminal 101, whose structure will be discussed in more detail with regard to FIG. 4, may be moving through coverage areas of RAN nodes 120a to 120d This is illustrated in FIG. 1 with wireless terminal 101 placed inside a bus. This placement serves to illustrate an exemplary situation in which the present disclosure may be practiced. Other examples include any common high-speed mode of transportation, such as trains, cars or planes. Wireless terminal 101 moves along the direction indicated by the dashed arrow at the bottom of FIG. 1 from the left to the right and thereby passes through the coverage area of RAN nodes 120a to 120c.

IAB relay node 110 may, like wireless terminal 101, be placed inside the bus and may thus likewise move with high velocity. IAB relay node 110 serves as a relay for RAN nodes 120a to 120d. In other words, IAB relay node 110 relays RAN signalling from RAN nodes toward wireless terminal 101, e.g. to provide better NR 5G coverage inside the bus. From the point of view of wireless terminal 101, IAB relay node 110 may thus be considered a RAN node defining a cell. The structure of IAB node 110 will be discussed in more detail with regard to FIGS. 2 to 4.

IAB relay node 110 is coupled to both wireless terminal 101 and first to RAN node 120a, then to RAN node 120b and finally to RAN node 120c. In other words, as both the IAB node 110 and the wireless terminal 101 move with the bus, the wireless terminal remains coupled to IAB node 110, while at the same time changing the RAN node IAB node 110 connects to.

It will be understood that wireless terminal 101 is referred to as being coupled to IAB node 110 in order to indicate that wireless terminal 101 may be or may transition to radio resource control (RRC) states in which an actual connection exists, i.e. in connected mode, in inactive mode or in idle mode with regard to the RAN node 120. Further, wireless terminal 101 is referred to as being coupled to IAB node 110 in order to indicate that wireless terminal 101 may transition to a connection with IAB relay node 110 in the connected mode from the inactive mode or the idle mode.

In the context of the present disclosure, the connection between RAN node 120 and wireless terminal 101 is assumed to be in the inactive mode. In the inactive mode, the data connection between wireless terminal 101 and IAB node 110 is disconnected or suspended. At the same time, a signaling connection between wireless terminal 101 and core network 200, e.g. an access and mobility function (AMF) of core network 200, remains in place. In other words, wireless device 101 may be in connection management (CM) connected mode. Further, the last serving RAN node of wireless terminal 101, which may e.g. be RAN node 120, stores the context of wireless terminal 101. The context may include any information required to maintain NG RAN services toward wireless terminal 101, such as capability information or state information of wireless terminal 101.

If core network 200 attempts to signal toward wireless terminal 101 in the inactive mode, the last serving RAN node 120 of wireless terminal 101 attempts to provide the signaling to wireless terminal 101 by paging wireless device 101 via all RAN nodes associated with an RNA of the last serving RAN node. Generally speaking, an RNA is an area within the RAN, in which wireless terminal 101 can move while in the inactive mode without having to perform a RNA Update when moving between coverage areas of RAN nodes included in the RNA. Only when entering a coverage area of an RAN node not included in the RNA is wireless terminal 101 required to perform an RNA update to move the UE context from one RNA to another and to switch the connection paths from core network 200 to the serving RAN node of the newly entered RNA.

This concept is illustrated in FIG. 1 by RNA 150a and RNA 150b and the arrow 600 between the two. When wireless terminal 101 and IAB relay node 110 leave the coverage area of RAN node 120b, wireless terminal 101 and relay node 110 leave RNA 150a and enter RNA 150b. Upon entering RNA 150b, wireless terminal 101 should perform an RNA update method, such as RNAU update method 600, which will be discussed with reference to FIG. 9.

In order to perform RNAU update 600, wireless terminal 101 needs to be aware that it has left RNA 150a and has entered RNA 150b. Typically, an RNA definition identifies all current cells associated with all RAN nodes of the RNA, i.e. a list of cells, including IAB relay nodes (cells) currently acting as IAB DU, but does not take into account IAB relay nodes not currently acting as IAB DU in the RNA. This may lead wireless terminal 101 to assume it has left an RNA when it selects a new suitable cell associated with a new IAB relay node connected to RAN node 120a or when the IAB relay node 110, monitored by wireless terminal 101, receives a new cell ID when the IAB relay node 110 moves through coverage areas of RAN nodes 120a and 120b together with wireless terminal 101. To avoid this, RAN nodes 120a to 120d and IAB relay node 110 respectively perform methods 400 and 500 illustrated in FIGS. 5 to 8, which will be discussed in the following.

FIG. 2 provides more detailed block diagrams RAN node 120a and IAB relay node 110 of FIG. 1. FIG. 2 further shows connections between the various blocks of RAN node 120a and IAB relay node 110 with each other as well as wireless terminal 101, core network 200 and an organization, administration and management function (OAM) 300.

OAM 300 provides provisioning and management functions, which enable e.g. the operator of the RAN formed by RAN nodes 120a to 120d and of core network 200 to manage and control RAN nodes 120a to 120d and of core network 200 to e.g. enable service provisioning as well as precise traffic prediction and optimization and to provide network status awareness and fault diagnosis. To this end, OAM 300 interfaces with core network 200. It will be understood that OAM may be coupled to other parts of the cellular network, such as the RAN formed by RAN nodes 120a to 120d.

RAN node 120a includes a distributed unit (DU) 121a and a centralized unit (CU) 122a. DU 121a provides support for the three lower protocol entities of the protocol stack of 5G NR, i.e. radio link control (RLC), medium access control (MAC) and the physical layer (PHY). Consequently, CU 122a provides support for the higher protocol entities of the protocol stack of 5G NR, i.e. RRC, service data adaptation protocol (SDAP) and packet data convergence protocol (PDCP).

As shown in FIG. 2, RAN node 120a includes one DU 121a and one CU 122a. However, while RAN nodes typically include a single CU 122a, they typically include a plurality of DUs 122a, with each DU capable of supporting one or more cells.

As shown in FIG. 2, DU 121a interfaces with CU 122a. This interface may also be referred to as an F1 interface. DU 121a further interfaces with IAB relay node 110 and may interface with wireless terminal 101, as indicated by the dashed connection. In both cases, the interface may also be referred to as the Uu interface. CU 122a interfaces with IAB relay node 110, via the F1 interface, and with core network 200. While the interface with core network 200 is shown as a single interface, it may in fact interface with core network 200 via multiple interfaces, such as the N2 interface, i.e. the control plane, to an AMF of core network 200, and the N3 interface, i.e. the user plane, to a user plane function (UPF) of core network 200. CU 122a may further interface with CUs of neighboring RAN nodes, such as a CU of RAN node 122b (not shown in FIG. 2). This interface may e.g. be the Xn interface.

Since RAN 120a is coupled to IAB relay node 110, DU 121a may also be referred to as an IAB donor DU and CU 122a may also be referred to as an IAB donor CU.

IAB relay node 110 follows the same CU/DU architecture as RAN node 120. Accordingly, IAB relay node includes a DU 111. Further, IAB relay node 110 includes a IAB UE. IAB relay node 110 thus includes an IAB UE 112. DU 111 interfaces with CU 122a via the F1 interface and may interface with wireless terminal 101 via the Uu interface. IAB UE 112 interfaces with DU 121a via the Uu interface.

The connections shown in FIG. 2 may correspond to a subset of the connections possible between the various entities of 5G system (5GS). For example, It will be understood that FIG. 2 shows both direct connections, such as the connection between core network 200 and CU 122a, and indirect connections, such as between DU 111 and CU 122a, which may be connected via IAB UE 112 and DU 121a. Such indirect connections may be transparent to intervening nodes. Further, it will be understood that more connections may be formed than shown in FIG. 2. An example is the N1 interface between wireless terminal 101 and core network 200, which is transparent to all nodes of the RAN.

FIG. 3 provides a more detailed overview of DU 121a and CU 122a of RAN node 120a. DU 121a may include a memory 121M, a control logic 121C and an interface circuit 1211. Likewise, CU 122a may include a memory 122M, a control logic 122C and an interface circuit 1221.

Control logic 121C and control logic 122C may be any kind of logic circuit enabling their respective functionality in the respective layers of the 5G NR protocol stack. In particular, control logic 121C and control logic 122C may be logic circuits configured to perform instructions implementing methods 400 to 600 discussed below. For example, control logic 121C and control logic 122C may be an application specific integrated circuit (ASIC) or a field-programmable gate array (FPGA) specifically tailored to the functions to be performed by control logic 121C and control logic 122C. Control logic 121C and control logic 122C may also be a general purpose logic circuit, such as a general purpose processor with one or more cores e.g. based on the x86 instruction set, the x86-64 instruction set, the ARM instruction set or the RISC-V instruction set.

Memory 121M and memory 122M may be any kind of memory circuit enabling storage of the instructions causing control logic 121C and control logic 122C to perform their respective functionality in the respective layers of the 5G NR protocol stack as well as associated data. In particular, memory 121M and memory 122M may store instructions implementing methods 400 to 600 discussed below. For example, memory 121M and memory 122M may be a soldi state disk or a hard disk drive or any kind or memory storage device configured to store the above-identified data and instructions.

Interface circuit 1211 and interface circuit 1221 are circuits enabling the various interface discussed above with regard to FIG. 2. Accordingly, interface circuit 1211 is configured to enable connectivity via the Uu interface of 5G NR and interface circuit 1221 is configured to provide connectivity via the N1 interface, the N2 interface, the N3 interface, the F1 interface and the XN interface. It will be understood that both interface circuit 1211 and 1221 may be configured to enable connectivity via other interfaces as well, as required by the deployment of RAN node 120a.

The communication between DU 121a and CU 122a may be performed directly between logic circuit 121C and logic circuit 122C, e.g. via an internal bus, or may be performed via interface circuit 1211 and interface circuit 1221. This is illustrated by the dashed bidirectional arrows between logic circuit 121C, logic circuit 122C, interface circuit 1211 and interface circuit 1221.

Given the structural similarity between DU 121a and CU 122a, it will be understood that the DU functionality may e.g. be integrated into the CU functionality. In examples, in which RAN node 120a includes a single DU, RAN node 120a may thus only include a combined CU and DU, as indicated by DU 121a illustrated as dashed boxes. Further, as already mentioned with regard to FIG. 2, RAN node 120a may include more than one DU 121a, which will have the same structure as discussed with regard to DU 121a.

Since IAB relay node 110 may, from the point of view of wireless terminal 101, appear like a RAN node, it will be understood that the structure of IAB relay node 110 may correspond to the structure discussed above with regard to RAN node 120a. In addition, it should be noted that, while FIGS. 2 and 3 only discuss RAN node 120a, the preceding discussion applies to all RAN nodes of the present disclosure.

FIG. 4 illustrates an example of the internal structure of wireless terminal 101. As shown in FIG. 4, wireless terminal 101 may include a memory 101M, a control logic 101C and an interface circuit 1011. Memory 101M, control logic 101C and interface circuit 1011 may be similar to the corresponding components of RAN node 120a adapted to perform the various functions of a wireless terminal, i.e. a UE, in 5G NR.

In some examples of IAB relay node 110, IAB relay node may in fact be a wireless terminal configured to perform the functions of an IAB relay node and thus of a RAN node. In such cases, control logic 101C may perform both the IAB UE and the DU functionality discussed above. It will be understood that, while control logic 101C may perform such functionality without any further modifications, interface circuit 1011 may require additional capabilities than a standard interface circuit of a wireless terminal in order to provide the connectivity of an IAB relay node discussed with reference to FIG. 2.

FIG. 5 provides a flowchart of a method 400 for use in a RAN node, such as RAN nodes 120a to 120d, which connect IAB relay nodes, such as IAB relay node 110, to a cellular network, such as the cellular network of FIG. 1, made up of core network 200 and the RAN formed by RAN nodes 120a to 120d. The RAN node, in which method 400 is used, is associated with an RNA for mobility management of wireless terminals, such as wireless terminal 101, operating in the inactive mode discussed above with reference to FIG. 1. In the following, method 400 will be discussed in the context of RAN node 120a. It will however be understood that method 400 may be employed by any one of RAN nodes 120a to 120d.

In the context of the present disclosure, mobility management is to be understood to refer to the management of any tasks, which need to be performed to maintain a connection with wireless terminal 101 as it moves through the coverage of RAN nodes 120a to 120d.

In step 410, method 400 obtains IAB RNA association information enabling RAN node 120a to prospectively associate IAB relay nodes, such as IAB relay node 110, that will newly connect to the RAN node with the same RNA as RAN node 120a. In the context of FIG. 1 and RAN node 120a, method 400 obtains IAB RNA association information which enable RAN node 120a to associate IAB relay node 100 with RNA 150a upon IAB relay node 110 entering the coverage area of RAN node 120a.

IAB RNA association information may be any kind of information enabling RAN 120a to associate IAB relay node 110 with the same RNA as RAN node 120a, i.e. RNA 150a. For example, the IAB RNA association information may define a pool of cell identities, which method 400 may assign to IAB relay nodes in step 430 discussed below. In such examples the IAB RNA association information may comprise a list of all cell identities in the pool, i.e. regardless of whether they are assigned to IAB relay nodes in step 430 or not. The IAB RNA association information may also comprise a ruleset enabling RAN node 120a to derive the cell identities in the pool. To further enable associating IAB relay nodes with an RNA, such as IAB relay node 110 with RNA 150a, the ruleset may map a cell identity of RAN node 120a to the cell identities included in the pool.

It will be understood that cell identity in the context of the present disclosure refers to the identity of a coverage area, i.e. a cell of a RAN node or an IAB relay node, respectively, used to uniquely identify the respective cell. For example, the cell identity may be broadcast as system information (SIB) and link to a system synchronization block (SSB) and more precisely to a primary synchronization signal (PSS) and a secondary synchronization signal (SSS) included in the SSB. Wireless terminal 101 may then derive the cell identity based on the PSS and the SSS or SIB. It will thus be understood that for example the definition of the pool of cell identities may be understood as providing a definition of a pool of PSS and a pool of SSS.

As stated above, the IAB RNA association information enables RAN node 120a to prospectively associate IAB relay nodes with the same RNA as RAN node 120a. In this context, prospectively refers to the fact that the IAB RNA association information enable RAN node 120a to associate any IAB relay nodes with the same RNA as RAN node 120a, which may, at some future point in time, connect to RAN node 120a. In other words, prospectively refers to the fact that the IAB RNA association information enable association of any IAB relay nodes with the RNA of RAN node 120a, not some specific IAB relay nodes which are known to connect with RAN node 120a or which may connect at specified points in time. This method allows the RAN node 120a to handle mobile IAB relay nodes that enter and leave the coverage area of RAN node 120a i.e. dynamically associate IAB nodes to the RAN nodes CU.

In step 420, method 400 provides RNA information to wireless terminal 101 based on the previously obtained IAB RNA association information upon releasing wireless terminal 101 connected to the RAN node to the inactive mode. In other words, method 400 provides the RNA information to wireless terminal 101 when the connection of wireless terminal 101 with the RAN of the cellular network transitions from the connected mode to the inactive mode e.g. in the release message including Inactive mode configurations.

The RNA information may be any kind of information ensuring that wireless terminal 101 is aware of the association of IAB relay node 110 with the same RNA as RAN node 120. To this end, the RNA information is based on the IAB RNA association information, i.e. the RNA information indicates the association of IAB relay node 110 with the RNA of RAN node 120a as performed by method 400 in step 430. For example, the RNA information may comprise a list of all cell identities in the pool discussed above. In particular, the RNA information may include cell identities included in the pool not assigned to any IAB node when method 400 provides the RNA information to wireless terminal 101.

In step 430, method 400 assigns a cell identity to the IAB relay node based on the previously obtained IAB RNA association information upon an IAB relay node newly connecting to the RAN node. For example, upon the bus of FIG. 1 and thereby IAB relay node 110 entering the coverage area of RAN node 120a, RAN node 120a may perform step 430 to assign a cell identity to IAB relay node 110, which is associated with RAN 150a due the IAB RNA association information. Accordingly, the cell identity assigned to IAB relay node 101 may be selected from the pool of cell identities discussed with reference to step 410. Assignment of the cell identity may occur via signaling over the F1 interface discussed above.

It should be noted that in some examples of the present disclosure, IAB relay node 110 may also self-assign the cell identity. In such examples, RAN node 120a may provide the pool of cell identities to IAB relay node 110 and IAB relay node selects one of the cell identities, e.g. based on a selection rule defined by one of core network 200 or OAM 300. This may e.g. occur if the connection between IAB UE 112 and DU 121a is in the inactive mode in order to avoid having to transition the connection the connected mode.

FIG. 6 provides a signaling diagram of the method of FIG. 5 according to embodiments of the present invention. The signaling diagram illustrates for the steps of method 400 how they relate to RAN node 120a as well as wireless terminal 101, core network 200 and OAM 300.

As discussed above, RAN node 120 obtains IAB RNA association information. As can be seen in FIG. 6, RAN node 120 may obtain IAB RNA association information by itself (arrow originating at and returning to RAN node 120a). In some examples, obtaining the RNA association information may also include receiving the IAB RNA association information from one of core network 200 or OAM 300. To account for the fact that any of the three obtaining options are optional, the arrows indicating step 410 are dashed in FIG. 6. In examples of the present disclosure, in which RAN node 120a obtains the IAB RNA association information by itself, RAN node 120a may e.g. derive IAB RNA association information based on the ruleset mentioned above. In examples of the present disclosure, in which RAN node 120a receives the IAB RNA association information from one of core network 200 and OAM 300, the IAB RNA association information may likewise be derived from e.g. the ruleset or may be determined based on network needs. In the case of OAM 300 providing the IAB RNA association information, the IAB RNA association information may also take into account specific requirements of the network provider.

Regarding step 420, FIG. 6 illustrates that step 420 includes signaling the RNA information to wireless terminal 101. Regarding step 430, FIG. 6 illustrates that step 430 includes signaling the assigned cell identity to IAB relay node 110.

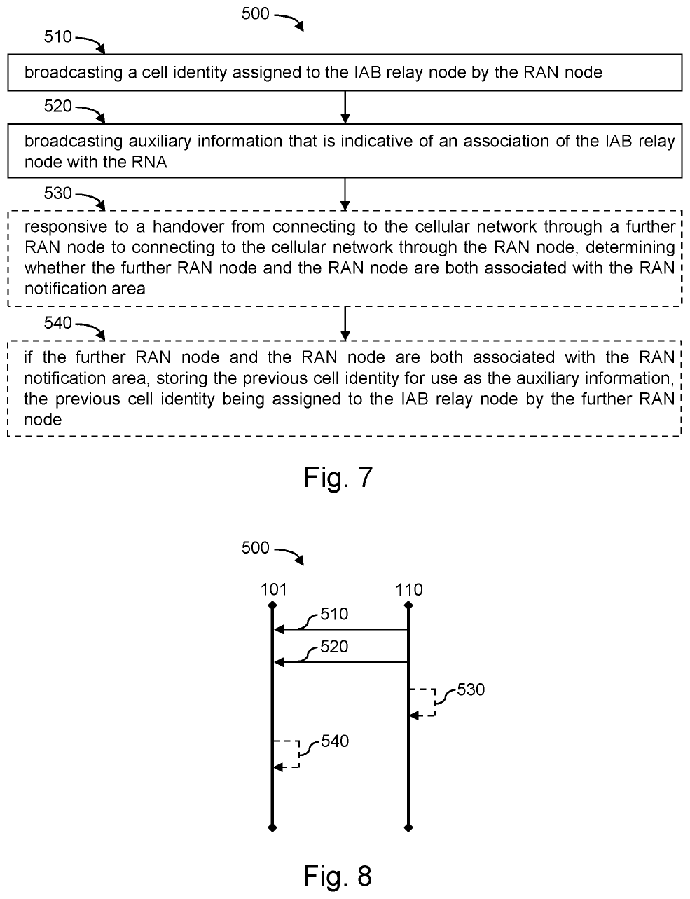

FIG. 7 provides a flowchart of a method 500 for use in an IAB relay node, such as IAB relay node 110, connected to a cellular network through a RAN node, such as RAN node 120a, of a RAN of the cellular network, such as the RAN formed by RAN nodes 120a to 120d. Both the RAN node and the IAB relay node are associated with an RNA for mobility management of the wireless terminals, such as wireless terminal 101, operating in an inactive mode discussed with reference to FIG. 1. Again using IAB relay node 110 and RAN node 120a in FIG. 1 as an example, IAB relay node 110 and RAN node 120a may be associated with RNA 150a. In the following, method 500 will be discussed in the context of IAB relay node 110 and RAN node 120a. It will however be understood that method 500 may be employed by IAB relay node 110 in the context of any one of RAN nodes 120a to 120d.

In step 510, method 500 broadcasts a cell identity assigned to IAB relay node 110 by RAN node 120a. For example, IAB relay node 110 may have been assigned a cell identity from the pool of cell identities residing in the RAN node 120a. It will however be understood that the cell identity of IAB relay node 110 may have been assigned by RAN node 120a based on a different approach. The assignment of the cell identity in method 500 is thus not be construed as being limited to the assignment based on method 400. As discussed above, broadcasting the cell identity may include broadcasting SSB or SIB, from which wireless terminals, such as wireless terminal 101, may derive the cell identity.

In step 520, method 500 broadcasts auxiliary information that is indicative of an association of the IAB relay node with the RNA. The auxiliary information may be any kind of information ensuring awareness of wireless terminal 101 with the association of IAB relay node 110 with e.g. RNA 150a. To this end, the auxiliary information may be indicative of an association between the IAB relay node and the RAN node. More precisely, the auxiliary information may comprise the cell identity of RAN node 120a to indicate e.g. the association with RNA 150. In some examples of the present disclosure, the auxiliary information may also comprise a previous cell identity of IAB relay node 110. In such examples, the previous cell identity of IAB relay node 110 may have been associated with an RNA and by including the previous cell identity in the auxiliary information, wireless terminal 101 may be able to determine the association of IAB relay node 110 with this RNA.

In step 530, method 500 may, responsive to a handover from connecting to the cellular network through a further RAN node to connecting to the cellular network through the RAN node, determine whether the further RAN node and the RAN node are both associated with the RAN notification area. For example, when IAB relay node 110 is handed over from RAN node 120a to RAN node 120b in FIG. 1, method 500 may in step 530 determine whether RAN node 120b is associated with the same RNA as RAN node 120a. As illustrated in FIG. 1, both RAN 120a and RAN 120b are associated with RAN 150a and are thus both associated with the same RNA.

In step 540, method 500 may, if the further RAN node and the RAN node are both associated with the same RAN notification area, store the previous cell identity for use as the auxiliary information, the previous cell identity being assigned to the IAB relay node by the further RAN node. To continue the example of FIG. 1, method 500 may thus store in step 540 the cell identity of RAN node 120a as the auxiliary information.

FIG. 8 provides a signaling diagram of the method of FIG. 7 according to embodiments of the present invention. As can be seen, the signaling of steps 510 and 520 of method 500 is performed from IAB relay node 110 toward wireless terminal 100. Steps 530 and 540 are performed by IAB relay node 110 internally, as indicated by the arrows returning to IAB relay node 110.

FIG. 9 provides a signaling diagram for an RNA update (RNAU) method 600, which may be used to transfer the context of wireless terminal 101 as well as the connections of wireless terminal 101 to core network 200 from one RNA to another. This is for example illustrated in FIG. 1 with handover arrow 600 from RNA 150a to RNA 150b.

As shown in FIG. 9 method 400 and method 500 discussed above may be performed prior method 600 starting at step 610. This is illustrated by the dashed arrows labeled 400 and 500, respectively. It will be understood that methods 400 and 500 are included as a single arrow in the signaling diagram of method 600 to generally illustrate when methods 400 and 500 may pe performed with respect to method 600. The individual steps of both method 400 and method 500 may be interwoven with the steps of method 600, as long as the association of IAB relay node 110 with an RNA, such as RNA 150a and RNA 150b, is known to wireless terminal 101 when triggering method 600.

In step 610, wireless terminal 101 detects, based on the association of IAB relay node 110 with an RNA known to wireless terminal 101 based on one of methods 400 and 500, that it has left an RNA, such as RNA 150a, due to a handover of IAB relay node 110 from RAN node 120b to RAN node 120c, and has entered RNA 150b.

Based on this detection, wireless terminal 101 signals in step 620 to RAN 120c to request to resume the connection to the RAN via IAB relay node 110 and RAN 120c in connected mode. As part of this request, wireless terminal 101 indicates, as the cause value for the request, that an RNA update is required. The request also provides an indication by the last serving RAN node, which may for example be RAN 120b. The signaling in step 620 occurs via IAB relay node 110, as indicated by the circle on the signaling indication of step 620 as the signaling indication crosses the signal bar of IAB relay node 110.

In step 630a, RAN node 120c signals toward the last serving RAN node, i.e. e.g. RAN node 120b, to request retrieval of the context of wireless terminal 101 stored in the last serving RAN node, as discussed above. In step 630b, RAN node 120b provides the response to the retrieval request by providing the context of wireless terminal 101 to RAN node 120c. It will be understood that RAN node 120b being the last serving RAN node is merely chosen as an example. If the last connection of wireless terminal 101 in connected mode existed between wireless terminal 101 and RAN node 120a, RAN node 120a, RAN node 120a would be the last serving RAN node. In other words, the last serving RAN node is generally the last RAN node to which wireless terminal 101 was connected to in connected mode.

Following retrieval of the context of wireless terminal 101, wireless terminal 101 returns to the inactive mode in step 640.

In optional step 650, RAN node 120c may indicate a forwarding address for downlink data for wireless terminal 101 buffered in RAN node 120b. This prevents loss of the downlink data.

In step 660a, RAN node 120c signals to core network 200 to switch the paths of the interfaces toward the core network discussed above, i.e. e.g. the paths through the N2 interface and the N3 interface, in order to reroute the paths through these interfaces to pass through the RAN node 120c instead of RAN node 120b. In step 660b, core network 200 responds to RAN node 120b by rerouting the paths.

In step 670, RAN node 120c signals to wireless terminal 101 that wireless terminal 101 can remain in the inactive mode since the RNA update has succeeded. This signaling is relayed by IAB relay node 110 to wireless terminal 101, as indicated in the same manner as the relay in step 620.

Finally, RAN node 120c signals RAN node 120b that it can release, e.g. delete, the context of wireless terminal 101 since the UE context retrieval of wireless terminal from RNA 150a to 150b has succeeded.

The invention may further be illustrated by the following examples.

In an example, a method for use in a RAN node of a RAN of a cellular network, the RAN node connecting IAB relay nodes to the cellular network, wherein the RAN node is associated with an RNA for mobility management of the wireless terminals operating in an inactive mode where a data connection between the respective wireless terminal and the RAN node is disconnected or suspended, the method comprising obtaining IAB RNA association information enabling the RAN node to prospectively associate IAB relay nodes that will newly connect to the RAN node with the same RNA as the RAN node, upon releasing a wireless terminal connected to the RAN node to the inactive mode, providing RNA information to the wireless terminal based on the previously obtained IAB RNA association information and upon an IAB relay node newly connecting to the RAN node, assigning a cell identity to the IAB relay node based on the previously obtained IAB RNA association information.

In an example, a method for use in a RAN node of a RAN of a cellular network, the RAN node connecting IAB relay nodes to the cellular network, wherein the RAN node is associated with an RNA for mobility management of the wireless terminals operating in an inactive mode where a data connection between the respective wireless terminal and the RAN node is disconnected or suspended, wherein the method may comprise obtaining information indicative of a pool of cell identities associated with the same RNA as the RAN node and reserved for IAB relay nodes that will newly connect to the RAN node, upon releasing a wireless terminal connected to the RAN node to the inactive mode, providing RNA information to the wireless terminal, the RNA information comprising a list of all cell identities included in the pool, upon an IAB relay node newly connecting to the RAN node, selecting a cell identity from the pool and assigning the selected cell identity to the IAB relay node.

In an example, the IAB RNA association information may define a pool of cell identities, and the cell identity assigned to the IAB relay node may be selected from the pool of cell identities.

In an example, the RNA information provided to the wireless terminal may comprise a list of all cell identities in the pool.

In an example, at least one of the cell identities included in the pool may not be assigned to any IAB node when providing the RNA information to the wireless terminal.

In an example, the method of any one of claims 2 to 4, the IAB RNA association information may comprise a list of all cell identities in the pool.

In an example, the IAB RNA association information may comprise a ruleset that enables the RAN node to derive the cell identities in the pool.

In an example, the ruleset may map a cell identity of the RAN node to the cell identities included in the pool.

In an example, said obtaining of the IAB RNA association indication may include receiving, from an organization, administration and management-OAM-function coupled to a core network of the cellular network, the IAB RNA association indication.

In an example, a RAN node of a cellular network, the RAN node connecting IAB relay nodes to the cellular network, wherein the RAN node is associated with an RNA for mobility management of the wireless terminals operating in an inactive mode where a data connection between the respective wireless terminal and the RAN node is disconnected or suspended, comprising a CU configured to interface with a DU—of one or more IAB relay nodes, and at least one DU, configured to interface with at least an IAB UE of an IAB relay node, wherein the CU is further configured to obtain IAB RNA association information enabling the RAN node to prospectively associate IAB relay nodes that will newly connect to the RAN node with the same RNA as the RAN node, upon releasing a wireless terminal connected to the RAN node to the inactive mode, provide RNA information to the wireless terminal based on the previously obtained IAB RNA association information, and upon an IAB relay node newly connecting to the RAN node, assign a cell identity to the IAB relay node based on the previously obtained IAB RNA association information.

In an example, the RAN node may further be configured to perform the method of any one of the above examples.

In an example, a method for use in an IAB relay node connected to a cellular network through a RAN node of a RAN of the cellular network, the RAN node and the IAB relay node both being associated with an RNA for mobility management of the wireless terminals operating in an inactive mode where a data connection between the respective wireless terminal and the RAN node is disconnected or suspended, the method comprising broadcasting a cell identity assigned to the IAB relay node by the RAN node, and broadcasting auxiliary information that is indicative of an association of the IAB relay node with the RNA.

In an example, the auxiliary information may be indicative of an association between the IAB relay node and the RAN node.

In an example, the auxiliary information may comprise the cell identity of the RAN node.

In an example, the auxiliary information may comprise a previous cell identity of the IAB node.

In an example, the method may further comprise, responsive to a handover from connecting to the cellular network through a further RAN node to connecting to the cellular network through the RAN node, determining whether the further RAN node and the RAN node are both associated with the RAN notification area, and, if the further RAN node and the RAN node are both associated with the RAN notification area, storing the previous cell identity for use as the auxiliary information, the previous cell identity being assigned to the IAB relay node by the further RAN node.

In an example, an IAB relay node connected to a cellular network through a RAN node of a RAN of the cellular network, the RAN node and the IAB relay node both being associated with an RNA for mobility management of the wireless terminals operating in an inactive mode where a data connection between the respective wireless terminal and the RAN node is disconnected or suspended, comprising a DU configured to interface with a CU of a RAN node and one or more UEs and an IAB UE configured to interface with a DU of the RAN node, wherein the DU of the IAB node is further configured to broadcast a cell identity assigned to the IAB relay node by the RAN node; and broadcast auxiliary information that is indicative of an association of the IAB relay node with the RNA.

In an example, the DU of the IAB node may further be configured to perform the method for use in an IAB relay node of any one of the above examples.

The preceding description has been provided to illustrate how to associate IAB nodes with the same RAN as the RAN node they are coupled to while ensuring awareness of the wireless terminal with the association. It should be understood that the description is in no way meant to limit the scope of the invention to the precise embodiments discussed throughout the description. Rather, the person skilled in the art will be aware that these embodiments may be combined, modified or condensed without departing from the scope of the invention as defined by the following claims.

1. A method for use in a radio access network (RAN) node of a RAN of a cellular network, the RAN node connecting integrated access and backhaul (IAB) relay nodes to the cellular network, wherein the RAN node is associated with a RAN notification area (RNA) for mobility management of the wireless terminals operating in an inactive mode where a data connection between the respective wireless terminal and the RAN node is disconnected or suspended,
wherein the method comprises:
obtaining IAB RNA association information enabling the RAN node to prospectively associate IAB relay nodes that will newly connect to the RAN node with the same RNA as the RAN node;
upon releasing a wireless terminal connected to the RAN node to the inactive mode, providing RNA information to the wireless terminal based on the previously obtained IAB RNA association information; and
upon an IAB relay node newly connecting to the RAN node, assigning a cell identity to the IAB relay node based on the previously obtained IAB RNA association information.

2. The method of claim 1,
wherein the IAB RNA association information defines a pool of cell identities, and
wherein the cell identity assigned to the IAB relay node is selected from the pool of cell identities.

3. The method of claim 2,
wherein the RNA information provided to the wireless terminal comprises a list of all cell identities in the pool.

4. The method of claim 3,
wherein at least one of the cell identities included in the pool is not assigned to any IAB node when providing the RNA information to the wireless terminal.

5. The method of claim 2,
wherein the IAB RNA association information comprises a list of all cell identities in the pool.

6. The method of claim 2,
wherein the IAB RNA association information comprises a ruleset that enables the RAN node to derive the cell identities in the pool.

7. The method of claim 6,
wherein the ruleset maps a cell identity of the RAN node to the cell identities included in the pool.

8. The method of claim 1,
wherein said obtaining of the IAB RNA association indication includes receiving, from an organization, administration and management (OAM) function coupled to a core network of the cellular network, the IAB RNA association indication.

9. A radio access network (RAN) node) a cellular network, the RAN node connecting integrated access and backhaul (IAB) relay) nodes to the cellular network, wherein the RAN node is associated with a RAN notification area (RNA) for mobility management of the wireless terminals operating in an inactive mode where a data connection between the respective wireless terminal and the RAN node is disconnected or suspended, comprising:
a centralized unit (CU) configured to interface with a distributed unit (DU) of one or more IAB relay nodes; and
at least one DU, configured to interface with at least an IAB user equipment (UE) of an IAB relay node,
wherein the CU is further configured to:
obtain IAB RNA association information enabling the RAN node to prospectively associate IAB relay nodes that will newly connect to the RAN node with the same RNA as the RAN node;
upon releasing a wireless terminal connected to the RAN node to the inactive mode, provide RNA information to the wireless terminal based on the previously obtained IAB RNA association information; and
upon an IAB relay node newly connecting to the RAN node, assign a cell identity to the IAB relay node based on the previously obtained IAB RNA association information.

10. (canceled)
